(19) United States
(12) Patent Application Publication
(10) Pub. No.: US 2025/0266230 A1
(43) Pub. Date: Aug. 21, 2025

(54) X-RAY TUBE

(71) Applicant: KETEK GmbH Halbleiter- und Reinraumtechnik, Munchen (DE)

(72) Inventors: Florian Schneider, Munchen (DE); Felix Düsberg, Munchen (DE); Michael Bachmann, Munchen (DE); Andreas Pahlke, Brunnthal (DE)

(21) Appl. No.: 18/442,334

(22) Filed: Feb. 15, 2024

(51) Int. Cl. H01J 35/14; H01J 35/18

(52) U.S. Cl. CPC H01J 35/153; H01J 35/18

(57) ABSTRACT

In an embodiment a X-ray tube includes an anode, a cathode, an electron emitter for generating free electrons, and an electron optics. The electron emitter is arranged in an emitter recess of the cathode. The electron optics is arranged at the recess and includes an opening such that the electron emitter is accessible in the opening. The opening widens in an acceleration direction of the free electrons.

### TECHNICAL FIELD

The present application refers to an X-ray tube.

### SUMMARY

Embodiments provide an improved X-ray tube that is in particular compact.

According to at least one embodiment, the X-ray tube comprises an anode and a cathode. A high voltage can be applied between the anode and cathode during intended operation of the X-ray tube. Free electrons that are generated at the cathode are accelerated towards the anode by an electric field emerging from the applied high voltage. For example, the high voltage is between 4 kV and 70 kV. The free electrons may be stopped at the anode and electromagnetic radiation, in particular X-rays, may be emitted as bremsstrahlung and characteristic X-ray emission lines of the anode material.

According to at least one embodiment, the X-ray tube comprises an electron emitter for generating free electrons. The electron emitter comprises, for example, a hot cathode or thermionic cathode, a semiconductor element, or an element configured to generate free electrons by means of field emission as well as hot electron emission. If the electron emitter is a hot cathode or a thermionic cathode, the electron emitter preferably comprises tungsten or alloys comprising tungsten.

According to at least one embodiment, the X-ray tube comprises an electron optics. The electron optics is in particular configured to shape a beam of free electrons between the cathode and the anode. For example, the free electrons may be influenced by a magnetic field. Additionally or alternatively, the electrical field established between the cathode and the anode due to the high voltage can be influenced by the electron optics. In this case, the electron optics may be passive. That is in particular, no additional power supply is applied to the electron optics.

According to at least one embodiment, the electron emitter is arranged in a focusing recess of the cathode. The recess may also be referred to as the Wehnelt recess, or the Wehnelt for short. It is possible that the electron emitter is arranged in a plane of the recess of the cathode, in a plane above, or in a plane below the recess of the cathode. An electron emitter recess width, for example a diameter of the recess, may be, for example, between 0.5 mm and 3 mm. For example, the electron emitter recess width is 1.5 mm.

According to at least one embodiment, the electron optics is arranged at the recess and comprises an opening such that the electron emitter is accessible in the opening. For example, the opening adjoins the recess in which the electron emitter is arranged. In particular, the electron optics directly adjoins the recess. That is, the opening is arranged in the vicinity of the electron emitter. For example, the opening follows the electron emitter directly in an acceleration direction of the free electrons. The acceleration direction of the free electrons is in particular a main direction in which the electrons are accelerated due to the electric field between the cathode and the anode during intended operation.

According to at least one embodiment, the opening widens in the acceleration direction of the free electrons. That is, a width or a diameter of the opening increases along the acceleration direction. In particular, the opening is narrower at a side facing the electron emitter than at a side facing away from the emitter. For example, the opening widens continuously. Alternatively or additionally, the opening may widen discretely. That is, for example, the opening may comprise one or more steps at an inner side surface.

In at least one embodiment the X-ray tube comprises an anode, a cathode, an electron emitter for generating free electrons, and an electron optics. The electron emitter is arranged in an emitter recess of the cathode. The electron optics is arranged at the recess and comprises an opening such that the electron emitter is accessible in the opening. The opening widens in an acceleration direction of the free electrons.

The X-ray tube described here is based, inter alia, on the following technical considerations. In particular for mobile applications, relatively compact and portable X-ray tubes are required that can be operated with comparably low power. At the same time such an X-ray tube must sustain a high voltage of up to 70 kV between the cathode and the anode at a tube power of 15 W. Furthermore, an electron beam between the cathode and a target layer at the anode for generating X-rays should be stable in space and over time. This consequently allows a stable emission of X-rays from the X-ray tube. Thereby, it is usually required that a focal spot of the tube is 1 mm or less, wherein the emission of photons by the X-ray tube is as efficient as possible. The focal spot should be stable, i.e., the focal spot should not drift over time. In particular, the focal spot should not drift with different applied high voltages and should not drift with different electron beam currents.

As mentioned above, a power consumption of the X-ray tube is advantageously comparably low, especially for mobile applications. This may be achieved by adapting the electron emitter to be, for example, a hot cathode and in addition adapting the focusing recess such, that electrons are extracted efficiently from the electron emitter. Typically, an active focusing of the free electrons generated by the electron emitter, for example by means of magnetic fields or an additional power supply, is omitted in order to save power consumption. As a result, focusing of the electron beam of the free electrons is achieved in particular solely by the geometry of the electron optics, i.e., its influence on the electric field shape that is established by the high voltage between the cathode and the anode.

The X-ray tube described herein makes use of the idea of forming the electron optics directly at the electron emitter such that an opening of the electron optics, in which the electron emitter is accessible, widens in an acceleration direction of the free electrons. It has been surprisingly shown that by such an opening the electric field between the cathode and the anode can be influenced such that a stable focusing of a resulting electron beam can be achieved. Furthermore, such electron optics allows for a comparably compact X-ray tube that can be operated with a high voltage of up to 70 kV, in particular and advantageously without additional power consumption needed for focusing the electrons.

In particular at the vicinity of the electron emitter, the generated free electrons comprise low to essentially no kinetic energy. Therefore, trajectories of the electrons inside the X-ray tube can be efficiently influenced in this region by shaping the electric field, i.e., the acceleration field. In particular, the more kinetic energy the electrons gain while accelerating towards the anode, the harder is a focusing by shaping the electric field. That is, at the opening of the electron optics the size and shape of the focal spot can be influenced most efficiently.

According to at least one embodiment, the X-ray tube comprises a target for generation of X-rays. A centre of a focal spot of an electron beam striking the target deviates from a central optical axis of the X-ray tube by at most 1 mm. The target is formed, for example, with tungsten, silver, gold and/or rhodium. During intended operation the free electrons generated by the electron emitter are accelerated towards the target by the electric field between the cathode and the anode. These electrons form the electron beam which strikes the target. At the target the electrons are stopped and thereby generate electromagnetic radiation, in particular, X-rays as bremsstrahlung and characteristic X-ray emission lines of the target material.

At the target the electron beam hits the anode surface, where the area from which X-rays emerge is defined as the focal spot. In particular, the focal spot has a diameter of less than 1 mm. The focal spot is measured, for example, according to an industry norm such as DIN EN 12543-5 or ASTM E1165. The focal spot is preferably independent of the high voltage applied to the X-ray tube and by a current of the electron beam. The focal spot deviates at most 1 mm from the central optical axis, which may be parallel to the acceleration direction of the electrons. The central optical axis may be defined as an axis along which the electron beam shows a local or a global maximum in intensity. Preferably, the focal spot or an intensity maximum of the focal spot does not deviate from its predefined position, for example according to DIN EN 12543-5, by at most 0.5 mm, independently of the high voltage and the current of the electron beam.

According to at least one embodiment, the electron optics comprises a plurality of steps such that a width of the opening increases with each step in the acceleration direction of the free electrons. That is, a widening of the opening in the acceleration direction is discrete. In particular, the width of the opening, and preferably of any other structural element of the X-ray tube, is measured in a direction perpendicular to the acceleration direction of the electrons.

For example, at a side facing the electron emitter the opening comprises a width between 0.5 mm and 3 mm. In acceleration direction, the opening comprises a plurality of steps, wherein a width of the opening increases by at least 0.1 mm after each step.

In particular, a thickness of the electron optics in a region surrounding the opening is between 0.01 mm and 3 mm. The thickness is measured in particular in a direction parallel to the acceleration axis of the electrons. The thickness of the electron optics is in particular identical to a thickness of the opening.

For example, the width of the opening at the side facing the electron emitter is 1.5 mm. A height of a first step, measured parallel to the acceleration direction, is, for example, 0.10 mm. A width of the opening after the first step is, for example, 2.5 mm. A height of a second step, following the first step in the acceleration direction, is, for example, 0.15 mm. A width of the opening after the second step that may be the width of the opening at a side facing away from the electron emitter is, for example, 3.2 mm. A height of a third step, following the second step, is, for example, 0.15 mm. Consequently, the thickness of the electron optics in a region surrounding the opening is 0.40 mm in the present example.

According to at least one embodiment, at least one inner side surface of the opening of the electron optics is tilted such that a width of the opening increases along the acceleration direction of the free electrons. In this case the widening of the opening may be continuous. For example, a width of the opening at the side facing the electron emitter may be between 0.5 mm and 3 mm, for example 1.5 mm. A width of the opening at the side facing away from the electron emitter may be between 1 mm and 3.5 mm, for example 3.2 mm.

It is possible that the inner side surfaces of the opening comprise tilted surfaces, steps and/or curves. That is, between the steps, where the width of the opening jumps, the side surfaces may be tilted.

According to at least one embodiment, at least one edge of the opening of the electron optics at the side facing away from the electron emitter is rounded. That is, this edge of the opening comprises no corner or the like. In particular, a path of the edge at the side of the opening facing away from the electron emitter forms a continuously differentiable curve.

It is possible that in this embodiment the inner side surfaces of the opening comprise tilted surfaces and/or steps and/or curves.

According to at least one embodiment, the electron optics comprises a focal cylinder that follows the opening of the electron optics in the acceleration direction of the free electrons. The focal cylinder and the region of the electron optics surrounding the opening may be formed as one piece. Alternatively, the focal cylinder may be separate from the region of the electron optics surrounding the opening and may be applied/attached to the opening.

A first width of the electron optics, which is in particular an inner diameter of the focal cylinder, is, for example, at least the size of the width of the opening at the side facing away from the electron emitter. Furthermore, the first width is preferably at most 12 mm. For example, the first width is between 3 mm and 8 mm, inclusive. For example, the first width is 6.4 mm or 5.7 mm.

A first height of the electron optics, which is in particular a height of the focal cylinder, is, for example, between 0.5 mm and 10 mm, for example 2.8 mm or 4 mm. The second height is in particular measured in a direction parallel to the acceleration direction starting from a plane in which the side of the opening facing away from the electron emitter is included.

A third width of the electron optics, which is in particular an outer diameter of the focal cylinder, is at least 0.5 mm larger than the first width, i.e., the inner diameter of the focal cylinder.

The electrical field between the cathode and the anode can be further influenced by the focal cylinder during intended operation, such that an effective focusing of the free electrons towards the anode and the target is possible.

According to at least one embodiment, the X-ray tube further comprises an evacuated tube. The cathode, the anode and the opening of the electron optics are arranged inside the evacuated tube. In particular, the focal cylinder is also arranged inside the evacuated tube. The electron optics may further comprise an outside cylinder arranged outside the evacuated tube. The outside cylinder is preferably electrically conductively connected to the cathode.

The evacuated volume is laterally, that is in directions perpendicular to the acceleration direction, confined by an electrical insulator. For example, the electrical insulator forms an insulative cylinder.

The electrical insulator in particular defines a distance between the cathode and the anode, which is preferably adapted such that a high voltage of up to 70 kV can be applied between the cathode and the anode without the emergence of a voltage breakdown between the cathode and the anode. A length of the insulative cylinder is, for example, at least 20 mm, for example at least 20.32 mm. For example, the length of the insulative cylinder is 24.15 mm. The length of the insulative cylinder is in particular measured in a direction parallel to the acceleration direction.

A distance between the insulative cylinder and the focal cylinder is, for example, at least 0.1 mm.

Preferably, the insulative cylinder is coated with a layer comprising a high electrical resistance on a side facing the evacuated volume. Potentially forming charge carriers can be dissipated by the layer with the high electrical resistance. The high resistance layer may comprise an aluminate, for example spinel (Mg Al2O4) and/or chromium aluminate.

A second width of the electron optics, which is in particular an inner diameter of the cylinder, is preferably between 8 mm and 16 mm, for example, 13 mm. For example, the second width is at least 0.1 mm wider than the insulative cylinder of the X-ray tube in a region of the anode. This allows for the arrangement of the outside cylinder after the X-ray tube is sealed. Hence, a focusing of the electron beam may optionally be tuned by the outside cylinder after sealing of the X-ray tube.

A second height of the electron optics, which is in particular a height of the outside cylinder, is, for example, at least such that the outside cylinder projects beyond the focal cylinder of the electron optics in the acceleration direction of the electrons. Additionally or alternatively, the second height is at most such that it does not project beyond a half of a minimal distance between the cathode and the anode. The distance between the cathode and the anode is also referred to as minimum voltage standoff (MVS). By choosing the second height in these limits, voltage breakthroughs can be avoided while at the same time the electrical field between the cathode and the anode can be influenced by the outside cylinder.

For example, the second height is between 2 mm and 20 mm, for example 10 mm.

A fourth width of the electron optics, which is in particular an outer diameter of the outside cylinder, is, for example, at least 0.5 mm larger than the second width, i.e., the inner diameter of the outside cylinder.

According to at least one embodiment, the cathode and the electron optics are at an electrical potential between −4 kV and −70 kV during operation of the X-ray tube. The anode is at an electrical potential of 0 V. That is, the X-ray tube may be operated with a high voltage of up to 70 kV. The high voltage is in particular an acceleration voltage for the free electrons generated by the electron emitter. In particular, the anode is electrically on ground. Preferably, all parts or elements of the electron optics such as the focal cylinder or the outside cylinder are electrically conductively connected with each other and preferably electrically conductively connected to the cathode. In particular, the electron optics is formed with an electrically conductive material such as a metal. For example, the electron optics may comprise at least one of the following materials: stainless steel, kovar (FeNiCo), molybdenum, an aluminum alloy, copper, a copper-based alloy.

According to at least one embodiment, an electron current is at least 200 uA if the X-ray tube is operated with a high voltage of 4 kV. For example, during operation the electron current is between 200 uA and 10,000 uA. The electron current is defined, for example, by the number of electrons reaching the anode during a certain period of time, multiplied by the elementary charge. A stable emission of X-ray photons by the X-ray tube can be achieved with such a high electron current.

According to at least one embodiment, the X-ray tube comprises a radiation window with a target. The radiation window is arranged along the acceleration direction of the free electrons. A photon emission direction, i.e., a main direction in which photons are emitted from the target, where the photons are generated, for example as bremsstrahlung and characteristic X-ray emission lines from the target, is in particular parallel to the acceleration direction of the electrons during operation. That is, the radiation window together with the target is operated in transmission. The photon emission direction is in particular the direction in which an intensity of the photons comprises a local or global maximum.

The radiation window comprises, for example, at least one of the following materials: beryllium, diamond, graphite, graphene or another suitable material.

If, for example, the radiation window is formed with beryllium, a thickness of the radiation window may be between 100 μm and 150 μm, for example, 125 μm. Alternatively, if the radiation window is formed with graphene, for example, the thickness of the radiation window may be between 20 μm and 50 μm, for example 40 μm.

With such material compositions and corresponding thicknesses, a mechanically stable radiation window can be formed that at the same time shows sufficient transmissivity for X-rays produced by the X-ray tube during operation.

The target is preferably arranged on a side of the radiation window facing the cathode. The target may comprise at least one of the following materials: silver, tungsten, rhodium, gold, chromium, copper, molybdenum, tantal, titanium.

According to at least one embodiment, the X-ray tube comprises a radiation window and a target, wherein the target comprises a target angle between 40° and 50° with respect to the acceleration direction of the free electrons. The radiation window follows the target in the photon emission direction. In particular the radiation window follows the target as a separate, distinct entity. That is, the radiation window and the target are not in direct mechanical contact and are arranged with a space between them. The target may comprise an outer surface that comprises the target angle. The target angle is, for example, 45°.

During operation, the electrons accelerated by the high voltage, strike the target at this angle. At the target, electromagnetic radiation, i.e., photons, is generated and emitted in the photon emission direction. The photons may leave the X-ray tube via the radiation window. Since the target is tilted with respect to the acceleration direction of the electrons, the main emission direction comprises an angle with respect to the acceleration direction. For example, the angle between the photon emission direction and the acceleration direction is between 80° and 100°, for example 90° in the case that the target angle is 45°. In particular, the radiation window comprises an angle of 90° with respect to the acceleration direction of the free electrons.

That is, the X-ray tube is operated in reflection in this embodiment. Such an X-ray tube is also referred to as a ‘reflection type tube’ or a ‘side window tube’.

According to at least one embodiment, the electron optics is electrically passive. This means in particular that no further electrical potential is applied to the electron optics, except the electrical potential of the cathode. A tuning of the electrical field between the cathode and the anode due to the electron optics hence emerges only because of the geometry of the electron optics. Advantageously, the electron optics is hence particularly easy to operate as no further control unit or the like is needed for the electron optics. This also allows reduced wiring and electronics complexity for operating the X-ray tube. Therefore, the X-ray tube may be particularly compact.

Alternatively, an electrical potential different to the potential of the cathode may be applied to at least a part of the electron optics, for example to the focal cylinder. This allows electron focusing properties of the electron optics to be actively influenced. For example, the outside cylinder may be on a different potential than the cathode and/or the electron optics arranged inside the evacuated tube. The outside cylinder is, for example, on a 10% higher or lower potential compared to the electron optics.

In particular, if a field emission device is used for the electron emitter, an electrical potential different to the potential of the cathode may be applied. This is particularly advantageous since electrons emitted by such an emitter may be more difficult to focus due to their higher initial kinetic energy compared, for example, to electrons generated by a hot cathode.

According to at least one embodiment, the X-ray tube comprises a maximal tube width of at least 10 mm or at least 15.25 mm and/or at most 20 mm. The tube width is in particular a maximal outer diameter of the X-ray tube. For example, the tube width is 14 mm.

According to at least one embodiment, the X-ray tube comprises a tube length between 20 mm and 60 mm, inclusive. The tube length is in particular a maximal length of the X-ray tube measured in a direction parallel to the acceleration direction of the free electrons. For example, the tube length is 34.5 mm.

According to at least one embodiment, the anode and/or the electron optics comprise a rotational symmetry with respect to the central optical axis between the cathode and the anode. In particular, the evacuated volume and the insulative cylinder also comprise the rotational symmetry with respect to the central optical axis. It is possible that the electron emitter does not comprise the rotational symmetry with respect to the central optical axis.

According to at least one embodiment, the anode comprises a backscatter protection. The backscatter protection is formed as an extrusion towards the cathode. That is, the backscatter protection is formed, for example, as a cylinder surrounding the electron beam towards the anode in the vicinity of the anode. Advantageously, the backscatter protection reduces the risk that electrons that are backscattered from the target are accelerated again by the electrical field between the cathode and the anode, which potentially widens the focal spot. Furthermore, the backscatter protection reduces the risk of backscattered electrons from the target striking the insulative cylinder, thereby harming its insulating properties.

According to at least one embodiment, the X-ray tube comprises a getter. In particular, the getter can be thermally or electronically activated. The getter is, for example, arranged in the vicinity of the cathode, in particular on a side of the cathode facing away from the anode and/or the electron optics. The getter is preferably configured to capture unwanted residual elements in the evacuated tube. This advantageously allows a low pressure to be sustained, i.e., a vacuum in the evacuated tube over an enhanced period of time.

According to at least one embodiment, the X-ray tube comprises a socket. In particular, the socket includes at least one electrical through-connection. The circuit is arranged, for example, at a side of the cathode and/or a side of the getter facing away from the anode.

The electrical through-connections may be electrically insulated with respect to a bottom of the socket. The bottom of the socket is a side of the socket facing away from the cathode. Alternatively, the electrical through-connections are electrically conductively connected to the bottom of the socket.

The electrical through-connections are in particular configured to electrically contact the electron emitter. Furthermore, the electrical through-connections may be configured to electrically contact the cathode. That is, for example, an electrical potential is applied to the cathode by the electrical through-connections.

Furthermore, the electrical through connections can be used during operation for activating the getter or applying an additional potential to at least parts of the electron optics.

Alternatively or additionally, the bottom of the circuit may comprise an outlet for evacuating the X-ray tube. A so-called ‘pinch-off’ may be achieved by the outlet. It is also possible that the socket is mounted to the evacuated volume under vacuum conditions.

In particular, it is possible that the X-ray tube comprises a plurality of electron emitters. For example, the plurality of electron emitters is electrically connected by through-connections through the socket.

According to at least one embodiment, a first ratio of the first height of the electron optics and the emitter width of the emitter recess is between 0.3 and 20.

In at least one embodiment the X-ray tube comprises an anode, a cathode, an electron emitter for generating free electrons and an electron optics comprising a first height. The electron emitter is arranged in an emitter recess of the cathode comprising an emitter recess width. The electron optics is arranged at the recess and comprises an opening such that the electron emitter is accessible in the opening. A first ratio of the first height of the electron optics and the emitter recess width is between 0.3 and 20.

According to at least one embodiment, a second ratio of the first width of the electron optics and the emitter recess width is at most 16. In this embodiment, the electron optics may comprise the focal cylinder.

According to at least one embodiment, an electron flight distance is defined by a distance between the electron emitter and the target. A third ratio of the electron flight distance and the tube diameter is at least 1.4. In this embodiment, the X-ray tube in particular comprises the evacuated tube that comprises the tube width and a target for generating X-rays. Furthermore, in this embodiment the cathode, the anode and the opening of the electron optics as well as the target are arranged inside the evacuated tube.

According to at least one embodiment, a fourth ratio of the second height of the electron optics to the first height of the electron optics is at most 20. In this embodiment, the X-ray tube further comprises the outside cylinder arranged outside of the evacuated tube.

By forming the X-ray tube in accordance with at least one of the first to fourth ratio, the X-ray tube may comprise a compact footprint, while at the same time a desired electron focusing at the target may be achieved.

According to at least one embodiment, the first height of the electron optics is between 1 mm and 10 mm, inclusive. The first width is between 3 mm and 8 mm, inclusive. In particular, the first width is a maximal first width. The emitter recess width is between 0.5 mm and 3 mm, inclusive. Preferably, the electron optics comprises the focal cylinder.

In at least one embodiment, the X-ray tube comprises an anode, a cathode, an electron emitter for generating free electrons, an electron optics comprising a first height and a first width. The electron emitter is arranged in an emitter recess of the cathode comprising an emitter recess width. The electron optics is arranged in an opening such that the electron emitter is accessible in the opening. The first height of the electron optics is between 1 mm and 10 mm, inclusive. The first width is between 3 mm and 8 mm, inclusive. The emitter recess width is between 0.5 mm and 3 mm, inclusive.

According to at least one embodiment, the thickness of the opening of the electron optics is between 0.01 mm and 3 mm. For example, a minimal distance between the electron emitter and the opening is between 0.01 mm and 0.5 mm. Preferably, a minimal distance between the cathode and the anode is at least 6.35 mm. The minimal distance between the cathode and the anode is also called ‘maximum voltage standoff length (MVS)’

According to at least one embodiment, the tube width is at least 10 mm and the tube length is between 20 mm and 45 mm. Preferably, the electron flight distance is at least 20 mm. Further preferably, the second height of the electron optics is between 2 mm and 20 mm, inclusive. Further preferably, the second width of the electron optics is between 8 mm and 16 mm, inclusive. In this embodiment, the X-ray tube preferably comprises an evacuated tube comprising an insulative cylinder, a target, and an outside cylinder.

Further advantages and advantageous embodiments and further developments of the X-ray tube described herein will become apparent from the following exemplary embodiments shown in connection with schematic drawings. Identical elements, elements of the same kind or elements having the same effect, are provided with the same reference signs in the figures. The figures and the proportions of the elements shown in the figures are not to be regarded as true to scale. Rather, individual elements may be shown exaggeratedly large for better representability and/or for better comprehensibility.

### BRIEF DESCRIPTION OF THE DRAWINGS

In the figures:

FIGS. 1 and 2 show schematic sectional views of an X-ray tube described herein according to exemplary embodiments;

FIG. 3 illustrates an intensity distribution of an electron beam between a cathode and an anode of an X-ray tube described herein;

FIGS. 4 to 6 show different exemplary embodiments for an opening of an electron optics of an X-ray tube described herein in schematic sectional views;

FIG. 7 shows a schematic sectional view of an X-ray tube described herein according to an exemplary embodiment; and

FIG. 8 shows a schematic sectional view of an electron optics for an X-ray tube described herein according to exemplary embodiments.

### DETAILED DESCRIPTION OF ILLUSTRATIVE EMBODIMENTS

Sections for the sectional views in the figures are taken along a plane defined by an acceleration direction of the free electrons and a direction orthogonal to this direction.

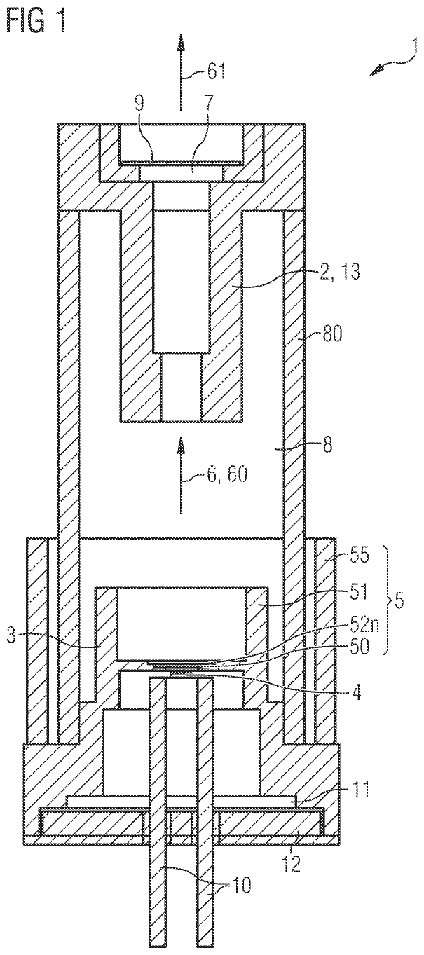

According to the exemplary embodiment of FIG. 1, the X-ray tube 1 comprises an anode 2 and a cathode 3. An electron emitter 4 is arranged in a recess of the cathode 3. The electron emitter 4 is a hot cathode for generating free electrons. The X-ray tube 1 is preferably rotationally symmetrical.

The X-ray tube 1 further comprises a radiation window 9 with a target 7. The radiation window 9 is formed, for example, with beryllium, diamond, graphite or graphene. The target 7 is arranged on a side of the radiation window facing the cathode 3. The target 7 comprises at least one of the following materials: silver, tungsten, gold, rhodium.

The X-ray tube 1 further comprises an evacuated tube 8 that is confined by an insulative cylinder 80. The anode 2, the cathode 3 and at least a part of an electron optics 5 are arranged in the evacuated tube 8.

During intended operation, a high voltage is applied between the cathode 3 and the anode 2. For example, the cathode 3 is set to an electric potential of −70 kV and the anode 2 is set to an electric potential of 0 V. The high voltage generates an electric field between the cathode 3 and the anode 2. The electron emitter 4 generates free electrons that are accelerated by the electrical field from the cathode 3 towards the anode 2 along an acceleration direction 6. At the target 7 the accelerated electrons are stopped, thereby generating electromagnetic radiation, i.e., photons. The photons are emitted in a photon emission direction 61. The photon emission direction 61 is a direction in which an intensity of photons emitted from the X-ray tube 1 shows a local or global maximum. The photon emission direction 61 is parallel to the acceleration direction 6.

It is desired that the accelerated electrons are focused on the target 7 to increase efficiency. A focal spot at the target 7 of the X-ray tube 1 deviates from a central optical axis 60, which is in particular a rotational symmetry axis of the X-ray tube 1 by at most 1 mm.

In order to achieve such focusing the X-ray tube 1 comprises an electron optics 5. The electron optics 5 comprises an opening 50 at the recess of the cathode 3, where the electron emitter 4 is arranged.

The opening 50 increases in width in the acceleration direction 6. In particular, the opening 50 comprises a plurality of steps 52n. The electron optics 5 further comprises a focal cylinder 51. Furthermore, the electron optics 5 comprises an outside cylinder 55 arranged outside of the evacuated tube 8.

The electron optics 5 is connected electrically conductive to the cathode 3. During operation of the X-ray tube 1 the electron optics 5 is preferably on the same electrical potential as the cathode 3. That is, the electron optics 3 is electrically passive.

The electrical field may be influenced at the vicinity of the electron emitter 4 by the opening 50. Since the free electrons comprise low kinetic energy in this region, forming the electrical field in this region is particular important and efficient. By the focal cylinder 52 and the outside cylinder 55, the electrical field may be further tuned to achieve the desired focusing of the electrons at the target 7.

The X-ray tube 1 further comprises a getter 11. The getter 11 is arranged on a side of the cathode 3 facing away from the anode 2. The getter 11 is configured to capture residual elements in the evacuated tube 8 so that a vacuum inside the evacuated tube 8 can be sustained.

The X-ray tube 1 further comprises a socket 12. The socket 12 is arranged on a side of the getter 11 facing away from the anode 2. Through the socket 12, electrical through-connections 10 are arranged. By means of the through-connections 10, the electron emitter 4, the cathode 3 and/or the getter 11 can be externally electrically contacted.

The X-ray tube 1 further comprises a backscatter protection 13 formed as an extrusion of the anode 2 towards the cathode 3. The backscatter protection 13 reduces the risk that electrons which are backscattered from the target 7 are accelerated again by the electrical field between the cathode 3 and the anode 2 and potentially widening the focus spot at the target 7. Furthermore, the backscatter protection 13 reduces the risk that backscattered electrons from the target 7 strike the insulative cylinder 80, thereby harming its insulating properties.

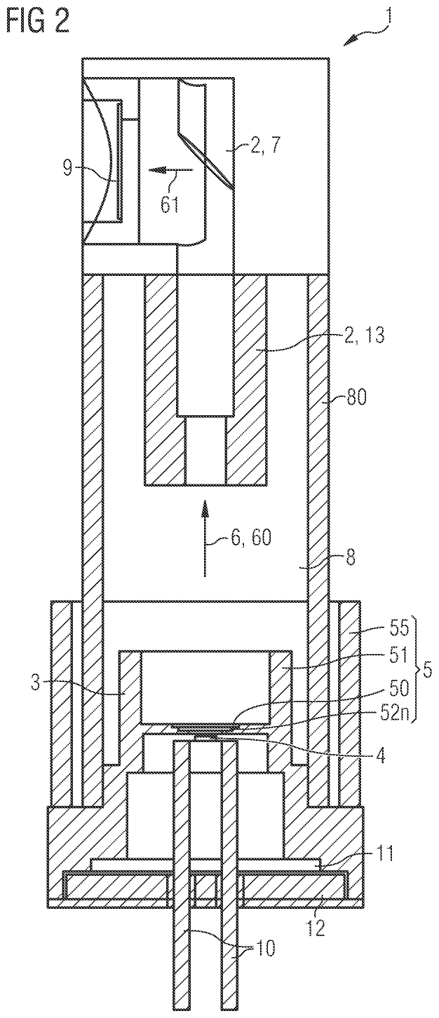

In contrast to FIG. 1, the photon emission direction 61 of the X-ray tube 1 according to the exemplary embodiment of FIG. 2 is perpendicular to the acceleration direction 6. The target 7 comprises a target angle of 45° with respect to the acceleration direction 6. Therefore, the photon emission direction 61 comprises an angle of 90° with respect to the acceleration direction 6. The radiation window 9 is arranged downstream of the target 9 in photon emission direction 61. Hence, the radiation window 9 is arranged at an angle of 90° with respect to the acceleration direction 6. The electron optics 5 of the X-ray tube 1 according to FIG. 2 are rotational symmetrical. In a region of the anode 2, where the target 7 and the radiation window 9 are arranged, the X-ray tube 1 does not show a rotational symmetry. In other aspects, the exemplary embodiment according to FIG. 2 shows the same features and effects as the exemplary embodiment according to FIG. 1.

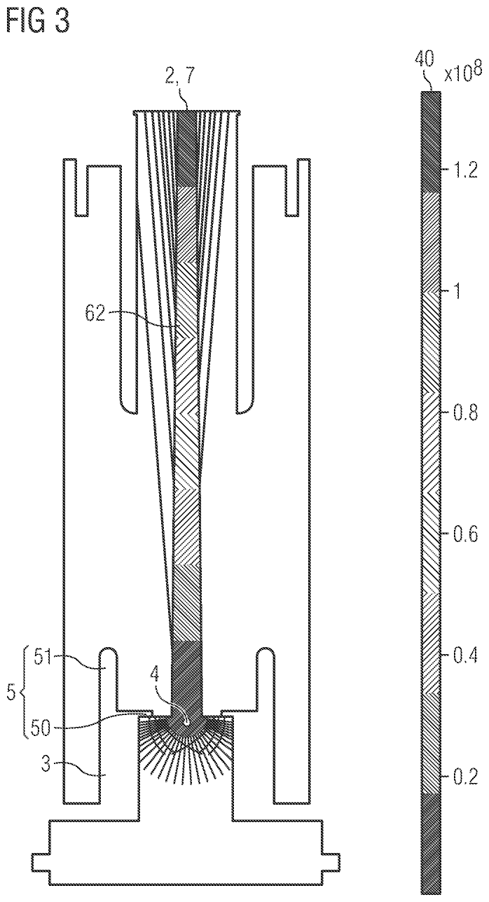

FIG. 3 illustrates electron trajectories 62 that are established in the evacuated tube 8 due to the high voltage between the cathode 3 and the anode 2. For example, the X-ray tube 1 illustrated in FIG. 3 is a schematic representation of the X-ray tube 1 according to FIG. 1. As can be seen from FIG. 3, the electron trajectories 62 are focused on the target 7, thereby creating a comparably narrow focal spot.

FIG. 3 further illustrates the kinetic energy of the free electrons 40 along a travelling distance from the anode 3 to the cathode 2, i.e., the target 7. As can been seen in FIG. 3, the trajectories 62 of the electrons are particularly focused in regions where the kinetic energy of the photons is small. For example, in regions where the kinetic energy 40 is lower than around 0.8 Joule essentially all trajectories are focused in one beam. With increasing kinetic energy 40, and hence with increasing distance from the electron emitter 4, more trajectories 62 may differ from the beam. However, a great majority, for example at least 90% of the trajectories 62 strike the target as a focused beam.

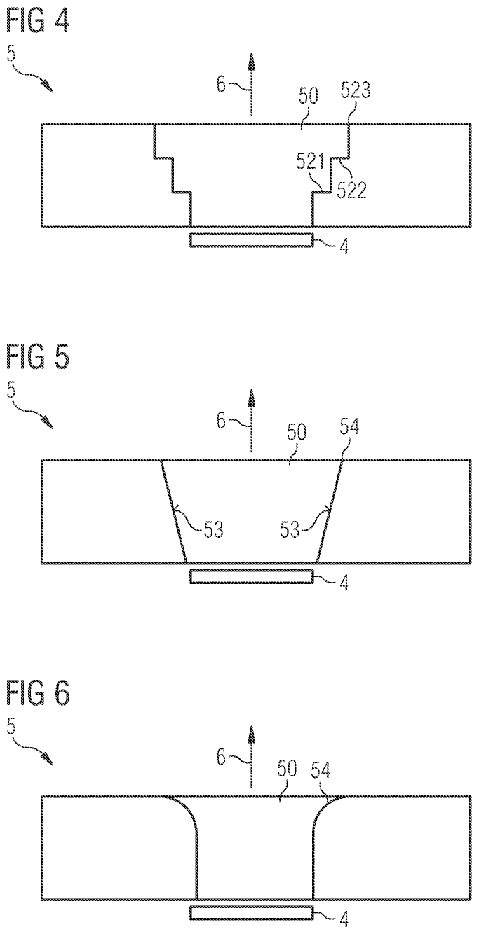

FIGS. 4 to 6 illustrate different exemplary embodiments of a widening of the opening 50 of the electron optics 5.

FIG. 4 the opening 50 comprises three steps. A first step 521 is arranged closest to the electron emitter 4, a third step 523 is arranged at a side of the opening 50 facing away from the electron emitter 4 and a second step 522 is arranged between the first step 521 and the third step 523.

In acceleration direction 6 the opening 50 comprises a first width at a side facing the electron emitter. After the first step 521 the opening 50 comprises a second width and after the second step 522 the opening 50 comprises a third width. The first width is smaller than the second width and the second width is smaller than the third width. In particular, the first width is a minimal width of the opening 50 and the third width is a maximum width of the opening 50. That is, in acceleration direction 6, the width of the opening 50 increases. In particular, the width of the opening 50 increases discretely. This means that at the steps 521 and 522 the width discontinuously jumps from the first width to the second width to the third width, respectively. In particular, the width of the opening 50 may remain constant or essentially constant between two steps 521, 522, 523.

In FIG. 5 the opening 50 widens continuously, wherein inner side surfaces 53 of the opening 50 are tilted such that the opening 50 widens in an acceleration direction 6.

In FIG. 6, an edge 54 of the opening 50 at a side facing away from the electron emitter 4 is rounded so that the opening 50 widens at said side.

It is possible that one or more exemplary embodiments for the opening 50 are combined. For example, an opening comprising steps 52n may have tilted inner side surfaces 53 between the steps 52n. Additionally, the opening 50 may have rounded edges 54, in case of, for example, multiple discrete steps.

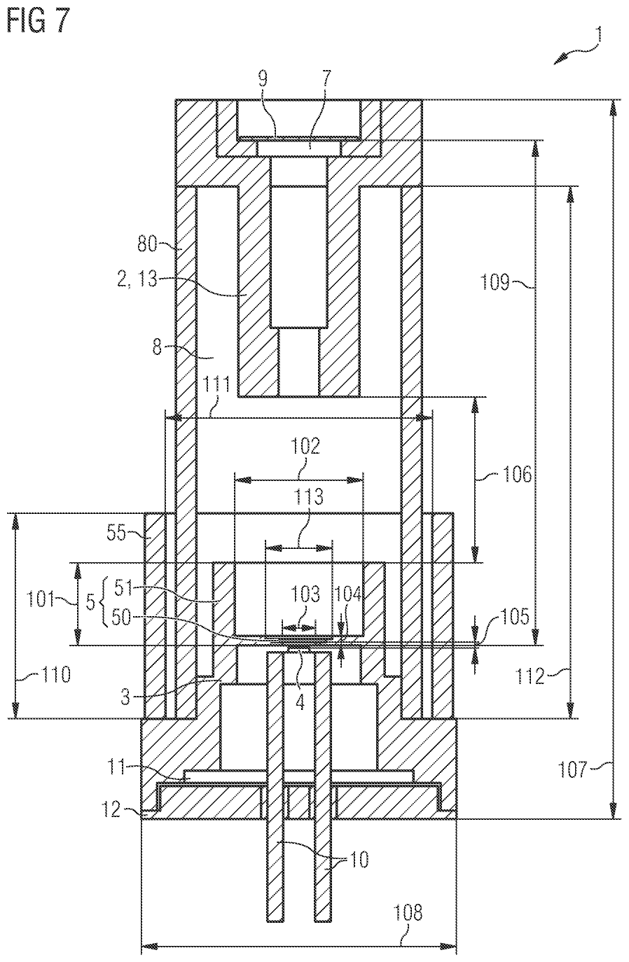

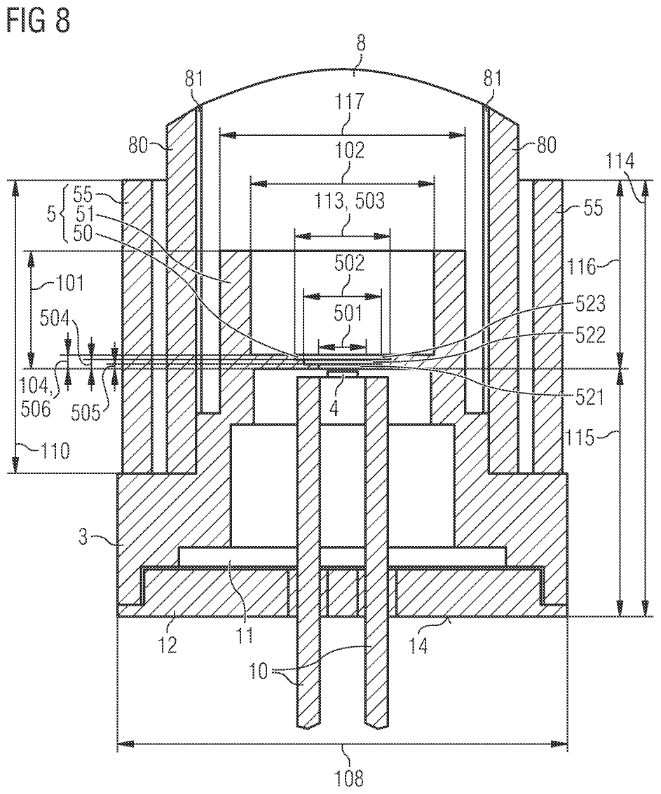

FIGS. 7 and 8 show dimensions of the X-ray tube 1 according to the exemplary embodiment of FIG. 1. FIG. 6 displays the X-ray tube 1 in a schematical sectional view. FIG. 8 shows a detailed representation of the X-ray tube 1 illustrating the cathode 3 and the electron optics 5 in more detail. Here and in the following, any width of any element is measured in a direction perpendicular to the acceleration direction 6. Furthermore, any length or any thickness is measured in a direction parallel to the acceleration direction.

The electron optics 5 comprises a first height 101 (FIGS. 7 and 8). The first height 101 is in particular a height of the focal cylinder 51. The first height 101 is between 1 mm and 10 mm, inclusive. In the present exemplary embodiment, the first height 101 is 2.8 mm.

The electron optics 5 comprises a first width 102 (FIGS. 8 and 8). The first width 102 is in particular an inner diameter of the focal cylinder 51. The first width 102 is between 3 mm and 8 mm, inclusive. In the present exemplary embodiment, the first width 102 is 5.7 mm.

The recess of the cathode in which the electron emitter 4 is arranged comprises an emitter recess width 103 (FIG. 7). The emitter recess width 103 is in particular a maximal width of the recess. The emitter recess width 103 is between 0.5 mm and 3 mm, inclusive. In the present exemplary embodiment, the emitter recess width 103 is 1.5 mm.

The opening 50 comprises a thickness 104 (FIGS. 7 and 8). The thickness 104 of the opening 50 is preferably identical with a thickness of the electron optics 5 in a region surrounding the opening 50. The thickness 104 of the opening 50 is between 0.01 mm and 3 mm, inclusive. In the present exemplary embodiment, the thickness 104 is 0.25 mm.

The X-ray tube 1 comprises a minimal distance 105 between the electron emitter 4 and the opening 50 (FIG. 7). The minimal distance 105 is between 0.01 mm and 0.5 mm, inclusive. In the present embodiment, the minimal distance 105 is 0.06 mm.

The X-ray tube 1 comprises a minimal distance 106 between the cathode 3 and the anode 2 (FIG. 7). The minimal distance 106 between the cathode 3 and the anode 2 is also called ‘maximum voltage standoff length’. The distance 106 is preferably such that a risk of a voltage breakthrough between the cathode 3 and the anode 2 is significantly reduced. The minimal distance 106 is at least 6.35 mm. In the present embodiment, the minimal distance 106 is 10.3 mm.

The X-ray tube 1 comprises a total tube length 107 (FIG. 7). The total tube length 107 is between 20 mm and 45 mm, inclusive. In the present embodiment, the tube length 107 is 34.5 mm.

The X-ray tube 1 comprises a tube width 108 (FIGS. 7 and 8). The tube width 108 is in particular a maximum width of the X-ray tube 1. The tube width 108 is at least 12 mm. In the present embodiment, the tube width 108 is 14 mm.

That is, the X-ray tube 1 is comparably compact.

The X-ray tube 1 comprises an electron flight distance 109 (FIG. 7), defined as a distance between the electron emitter 4 and the target 7. The electron flight distance 109 is at least 20.32 mm. In the present embodiment the electron flight distance 109 is 25.46 mm.

The electron optics 5 comprises a second height 110 (FIGS. 7 and 8). The second height 110 is in particular a height of the outside cylinder 55. The second height 110 is between 2 mm and 20 mm, inclusive. In the present exemplary embodiment, the second height 110 is 10 mm.

The electron optics 5 comprises a second width 111 (FIG. 7). The second width 111 is in particular an inner diameter of the outside cylinder 55. The second width 111 is between 8 mm and 16 mm, inclusive. In the present exemplary embodiment, the second width 111 is 13 mm.

The insulative cylinder 80 comprises a length 112 (FIG. 7). The length 112 of the insulative cylinder 80 is at least 17.78 mm. In the present exemplary embodiment, the length 112 of the insulative cylinder 80 is 24.15 mm.

The opening 50 comprises a maximal width 113 (FIGS. 7 and 8). The opening 50 comprises the maximal width 113 at a side facing away from the electron emitter 4. The maximal width 113 of the opening 50 is between the emitter recess width 103 and the first width 102. In the present exemplary embodiment, the maximal width 113 of the opening 50 is 3.2 mm.

The socket 12 comprises a bottom 14. The bottom 14 of the socket 12 is a side of the socket 12 facing away from the cathode 3. The bottom 14 of the socket 12 is in particular also a bottom of the X-ray tube 1.

An outside cylinder distance 114 between a side of the outside cylinder 55 facing away from the socket 12 and the bottom 14 in the acceleration direction 6 is, for example, 15 mm (FIG. 8). The outside cylinder distance 114 comprises a first part 115 and a second part 116. The first part 115 is a distance between the bottom 14 and a side of the opening 50 facing the electron emitter 4. The first part 115 comprises a length of, for example, 7.13 mm. The second part 116 is the difference between the outside cylinder distance 116 and the first part 115. The second part 116 comprises a length of, for example, 6.45 mm.

The electron optics 5 comprises a third width 117 (FIG. 8). The third width 117 is in particular an outside diameter of the focal cylinder 55. The third width 117 is, for example, 7.1 mm.

The opening 50 of the electron optics comprises a plurality of steps 521, 522, 523 (FIG. 8). At a first step 521 the opening 50 comprises a width 501 of 1.5 mm. The first step 521 is arranged at a side of the opening 50 facing the electron emitter 5. At a second step 522, following the first step 521 in acceleration direction 6, the opening 50 comprises a width 502 of 2.5 mm. At a third step 523, following the second step in acceleration direction 6, the opening 50 comprises a width of 3.2 mm. The third step 523 is arranged at a side of the opening 50 facing away from the electron emitter 4. That is, width 503 at the third step 523 is the maximal width of the opening 113.

Each step 521, 522, 523 comprises a height of, for example, 0.1 mm or 0.15 mm or 0.25 mm. That is, at the first step 521, the opening 50 comprises a thickness 504 of 0.1 mm. At the second step 522, the opening 50 comprises a thickness 505 of 0.25 mm. At the third step 523 the opening comprises a thickness 506 of 0.5 mm.

Furthermore, FIG. 8 illustrates that the insulative cylinder 80 may comprise a layer with a high electrical resistance 81 at a side facing the evacuated tube 8. The layer with the high electrical resistance 81 is formed from an aluminate such as spinel (MgAl2O4) or chromium aluminate. Potentially forming charge carriers in the evacuated volume 8 can be dissipated by the layer with the high electrical resistance 81. Such a layer with a high electrical resistance 81 can be present in all other exemplary embodiments.

The invention is not restricted to the exemplary embodiments of the description on the basis of said exemplary embodiments. Rather, the invention encompasses any new feature and also any combination of features which in particular comprises any combination of features in the patent claims and any combination of features in the exemplary embodiments, even if this feature or this combination itself is not explicitly specified in the patent claims or exemplary embodiments.

What is claimed is:

1. An X-ray tube comprising:
an anode;
a cathode;
an electron emitter configured to generate free electrons; and
an electron optics,
wherein the electron emitter is arranged in an emitter recess of the cathode,
wherein the electron optics is arranged at the recess and comprises an opening such that the electron emitter is accessible in the opening, and
wherein the opening widens in an acceleration direction of the free electrons.

2. The X-ray tube according to claim 1, further comprising a target configured to generate X-rays, wherein a center of a focal spot of an electron beam striking the target deviates from a central optical axis of the X-ray tube by at most 1 mm.

3. The X-ray tube according to claim 1, wherein the electron optics comprises a plurality of steps such that a width of the opening increases with each step in the acceleration direction of the free electrons.

4. The X-ray tube according to claim 1, wherein at least one inner side surface of the opening is tilted such that a width of the opening increases along the acceleration direction of the free electrons.

5. The X-ray tube according to claim 1, wherein at least one edge of the opening of the electron optics at a side facing away from the electron emitter is rounded.

6. The X-ray tube according to claim 1, wherein the electron optics comprises a focal cylinder, following the opening of the electron optics in the acceleration direction of the free electrons.

7. The X-ray tube according to claim 1, further comprising:
an evacuated tube,
wherein the cathode, the anode and the opening of the electron optics are arranged inside the evacuated tube, and
wherein the electron optics comprises an outside cylinder arranged outside the evacuated tube and electrically conductively connected to the cathode.

8. The X-ray tube according to claim 1, wherein the cathode and the electron optics are at an electric potential between −4 kV and −70 kV and the anode is at an electric potential of 0V.

9. The X-ray tube according to claim 1, wherein an electron current is at least 200 uA at a high voltage of 4 kV of the X-ray tube.

10. The X-ray tube according to claim 1, further comprising a radiation window with a target, wherein the radiation window is arranged along the acceleration direction of the free electrons.

11. The X-ray tube according to claim 1, further comprising a radiation window and a target, wherein the target comprises a target angle between 40° and 50° with respect to the acceleration direction of the free electrons, and wherein the radiation window follows the target in a photon emission direction.

12. The X-ray tube according to claim 1, wherein the electron optics is electrically passive.

13. An X-ray tube comprising:
an anode;
a cathode;
an electron emitter configured to generate free electrons; and
an electron optics comprising a first height,
wherein the electron emitter is arranged in an emitter recess of the cathode comprising an emitter recess width,
wherein the electron optics is arranged at the recess and comprises an opening such that the electron emitter is accessible in the opening, and
wherein a first ratio of the first height of the electron optics and the emitter recess width is between 0.3 and 20.

14. The X-ray tube according to claim 13,
wherein the electron optics comprises a first width, and
wherein a second ratio of the first width of the electron optics and the emitter recess width is at most 16.

15. The X-ray tube according to claim 13, further comprising:
an evacuated tube comprising a tube width; and
a target configured to generate X-rays,
wherein the cathode, the anode, the opening of the electron optics and the target are arranged inside the evacuated tube,
wherein an electron flight distance is defined by a distance between the electron emitter and the target, and
wherein a third ratio of the electron flight distance and a tube diameter is at least 1.4.

16. The X-ray tube according to claim 15,
wherein the electron optics comprises an outside cylinder arranged outside of the evacuated tube, and
wherein a fourth ratio of a second height of the electron optics to the first height of the electron optics is at most 20.

17. An X-ray tube comprising:
an anode;
a cathode;
an electron emitter for generating free electrons; and
an electron optics comprising a first height and a first width,
wherein the electron emitter is arranged in an emitter recess of the cathode comprising an emitter recess width,
wherein the electron optics is arranged at the recess and comprises an opening such that the electron emitter is accessible in the opening,
wherein the first height is between 1 mm and 10 mm, inclusive,
wherein the first width is between 3 mm and 8 mm, inclusive, and
wherein the emitter recess width is between 0.5 mm and 3 mm, inclusive.

18. The X-ray tube according to claim 17,
wherein a thickness of the opening is between 0.01 mm and 3 mm, inclusive,
wherein a minimal distance between the electron emitter and the opening is between 0.01 mm and 0.5 mm, inclusive, and
wherein a minimal distance between the cathode and the anode is at least 6.35 mm.

19. The X-ray tube according to claim 17, further comprising:
an evacuated tube with a tube width and a tube length and comprising an insulative cylinder; and
a target configured to generate X-rays,
wherein the electron optics comprises an outside cylinder arranged outside of the evacuated tube,
wherein the tube width is at least 10 mm and the tube length is between 20 mm and 45 mm, inclusive,
wherein an electron flight distance, defined by a distance between the electron emitter and the target, is at least 20.32 mm,
wherein a second height of the outside cylinder is between 2 mm and 20 mm, inclusive, and
wherein a second width of the outside cylinder is between 8 mm and 16 mm, inclusive.
